(19) United States
(12) Patent Application Publication
(10) Pub. No.: US 2018/0185942 A1
(43) Pub. Date: Jul. 5, 2018

(54) High Temperature Casting and Electrochemical Machining Heat Exchanger Manufacturing Method

(71) Applicant: X Development LLC, Mountain View, CA (US)

(72) Inventors: Raj Apte, Mountain View, CA (US); Philippe Larochelle, Mountain View, CA (US)

(21) Appl. No.: 15/393,891

(22) Filed: Dec. 29, 2016

(51) Int. Cl. B23H 3/00; B23H 3/04; B23H 7/30; B23H 7/08; F28D 7/16; F28F 9/04; F28F 9/013

(52) U.S. Cl. CPC B23H 3/00; B23H 3/04; B23H 7/30; F28F 9/0131; F28D 7/16; F28F 9/04; B23H 7/08

(57) ABSTRACT

Modular tubing apparatuses for use in a shell-and-tube heat exchanger are described. Multiple apparatuses may be connected in series to form a high density, small tube diameter, long length tube apparatus assembly. Casting molds for forming modular tubing apparatuses are likewise described, including methods for casting and electrochemically machining such apparatuses.

### BACKGROUND

Unless otherwise indicated herein, the materials described in this section are not prior art to the claims in this application and are not admitted to be prior art by inclusion in this section.

High performance heat exchangers that achieve very low approach temperatures (for example, effectiveness greater than 99%) and very low pressure drops (for example, less than 5% or 1% calculated as (change in pressure)/(inlet pressure) across the heat exchanger) generally require very small diameter (for example, less than 10 mm) fluid passages with long lengths (for example, 0.5 m or 1 m or greater). Forming a large quantity of fluid passages (for example, greater than 100,000) with the above noted dimensions and then assembling enough of them in parallel to achieve large heat duties, such as might be used on a grid-scale energy generation or storage system, represents a significant manufacturing challenge.

Conventional methods of constructing shell-and-tube heat exchangers with long length, small diameter tubes have significant limitations. To form the tubes, mandrel rod drawing or floating plug drawing is typically used, but there are limitation such as manufacturing throughput, the need for intermediate tube diameters for drawing over the mandrel or plug, and additional secondary operations, such as mandrel reeling (removal). Finally, a dense array of individual tubes must then be coupled to an input plenum and output plenum in a time consuming and sometimes low-reliability assembly process.

### SUMMARY

Disclosed herein are modular tube apparatuses for shell-and-tube heat exchangers, and molds and methods for forming the apparatuses.

Example mold assemblies may include a bottom mold portion that may include a bottom block that may include a top surface and a plurality of cavities in the bottom block extending downwardly from the top surface to a first depth. Example mold assemblies may further include a top mold portion that may include a top plate positioned opposite and at a first distance from the top surface of the bottom block and a plurality of protrusions extending downwardly from the top plate, wherein each protrusion of the plurality of protrusions forms a seal at the top surface of the bottom block. Example mold assemblies may further include a middle mold portion that may include a wall that forms a seal between the top plate and the bottom block around the periphery of a void space between the top plate and the bottom block.

Example methods may include providing a modular tube apparatus casting, wherein the casting may include a connecting plate and a plurality of cylinders extending downward from the connecting plate. Example methods may further include providing an electrochemical machining assembly, wherein the assembly may include a base and a plurality of wire cathodes, wherein each wire cathode may include a spherical tip, and wherein each wire cathode of the plurality of wire cathodes may be arranged to align with a respective cylinder of the plurality of cylinders. Example methods may further include contacting the spherical tips of the plurality of wire cathodes to the casting and moving the plurality of wire cathodes through the plurality of cylinders to form a plurality of hollow tubes.

Other example methods may include providing a modular tube apparatus casting, wherein the casting may include a connecting plate and a plurality of cylinders extending downward from the connecting plate. Example methods may further include providing an electrochemical machining assembly, wherein the assembly comprises a base and a plurality of wire cathodes, wherein each wire cathode may include a spherical tip, wherein each wire cathode of the plurality of wire cathodes may be arranged to align with a respective cylinder of the plurality of cylinders. Example methods may further include contacting the spherical tips of the plurality of wire cathodes to the casting and moving the plurality of wire cathodes through the plurality of cylinders to form a plurality of hollow tubes.

These as well as other aspects, advantages, and alternatives, will become apparent to those of ordinary skill in the art by reading the following detailed description, with reference where appropriate to the accompanying drawings.

### BRIEF DESCRIPTION OF THE FIGURES

FIGS. 1A and 1B depict, respectively, a bottom perspective view and a top perspective view of a modular tube apparatus, according to an example embodiment.

FIG. 1C depicts a cross-section view of a modular tube apparatus, according to an example embodiment.

FIG. 2A depicts a side perspective view of two modular tube apparatuses, according to an example embodiment, coupled together in series.

FIG. 2B depicts a cross-section view of two modular tube apparatuses, according to an example embodiment, coupled together in series.

FIG. 3 depicts a side perspective view of a top mold portion of a mold assembly, according to example embodiments.

FIG. 4 depicts a side perspective view of a top mold portion of a mold assembly, according to example embodiments.

FIG. 5 depicts a side perspective view of a top mold portion of a mold assembly, according to example embodiments.

FIG. 6 depicts a perspective view of a middle mold portion and a bottom mold portion of a mold assembly, according to an example embodiment.

FIG. 7 depicts a cross-section view of an assembled mold assembly with a top mold portion, middle mold portion, and bottom mold portion, according to example embodiments.

FIG. 8 depicts a cross-section view of an assembled mold assembly with a top mold portion, middle mold portion, and bottom mold portion, according to example embodiments.

FIG. 9 depicts a cross-section view of an assembled mold assembly with a top mold portion, middle mold portion, and bottom mold portion, according to example embodiments.

FIG. 10 depicts a cross-section view of a modular tube apparatus and cathode assembly, according to an example embodiment.

### DETAILED DESCRIPTION

Example methods and systems are described herein. It should be understood that the words “example” and “exemplary” are used herein to mean “serving as an example, instance, or illustration.” Any embodiment or feature described herein as “example,” “exemplary,” or “illustrative” is not necessarily to be construed as preferred or advantageous over other embodiments or features. More generally, the embodiments described herein are not meant to be limiting. It will be readily understood that certain aspects of the disclosed methods systems and can be arranged and combined in a wide variety of different configurations, all of which are contemplated herein.

### I. Overview

Example embodiments herein generally relate to modular tube portions of shell-and-tube heat exchanger apparatuses, and molds and methods for forming the modular tube portions. In a preferred embodiment, a modular tube apparatus for use in a shell-and-tube heat exchanger may include a connecting plate with an arrangement of receiving cups on one side and small diameter long tubes on the other side. The modular apparatus may be configured such that multiple apparatuses may be connected in series with the tubes of one apparatus mating to the receiving cups of the next apparatus in series to form a very long tube assembly with a high-density of small diameter tubes. This beneficially provides a high heat transfer design within a shell-and-tube heat exchanger. Preferably, this type of modular apparatus may be formed as a unitary homogenous body within a casting mold specifically designed to allow the formation of a connecting plate with integral long small diameter cylinders. In a preferred embodiment, solid cylinders may be electrochemically machined to remove material from the center of the tubes to create the long small diameter tubes. The connecting plate may additionally include one or more through holes to, for example, allow a thermal fluid to flow through the apparatus and aid heat transfer with a working fluid flowing through the tubes.

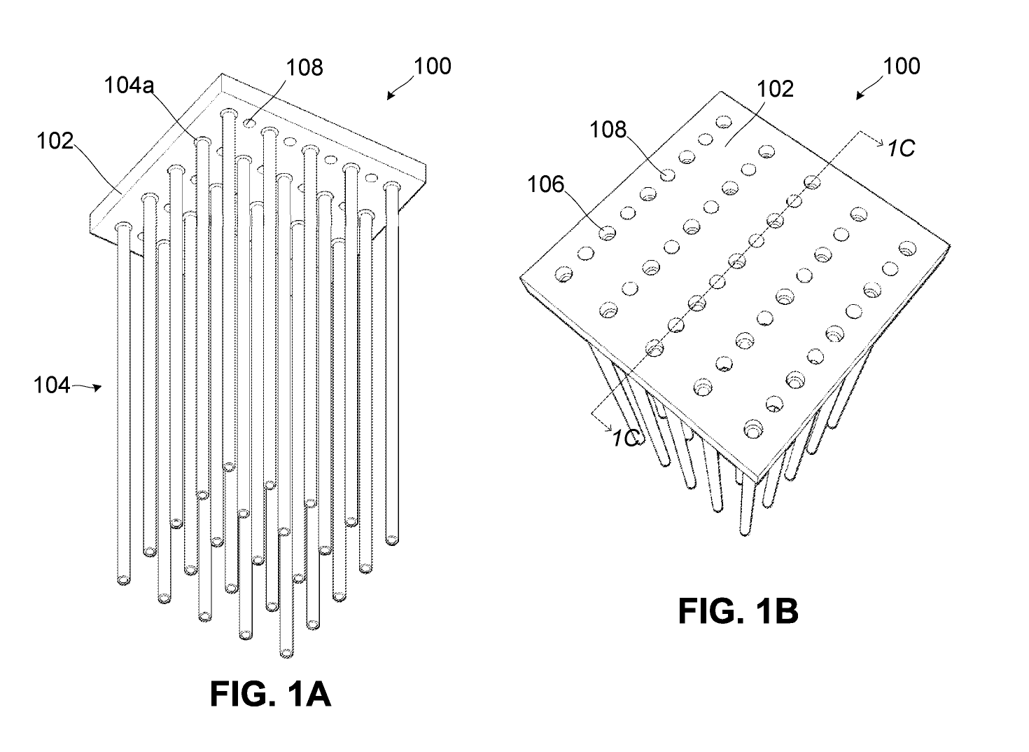

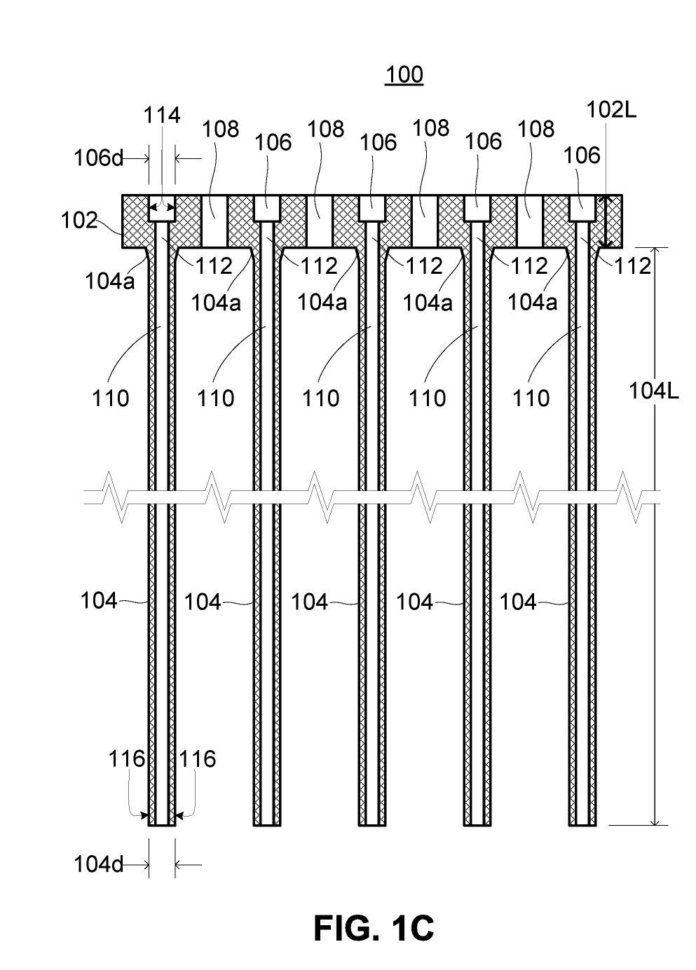

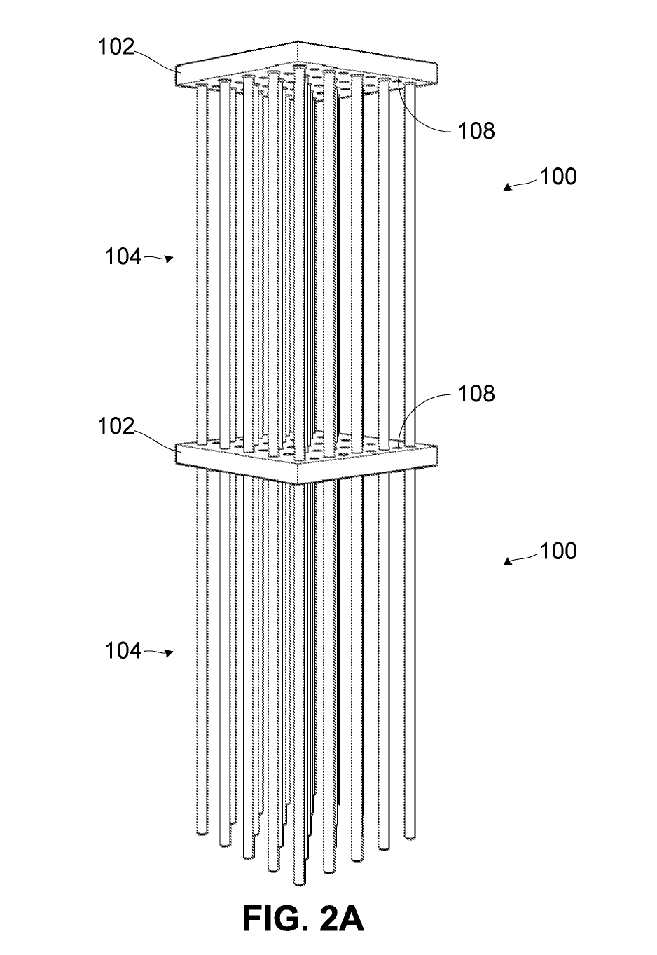

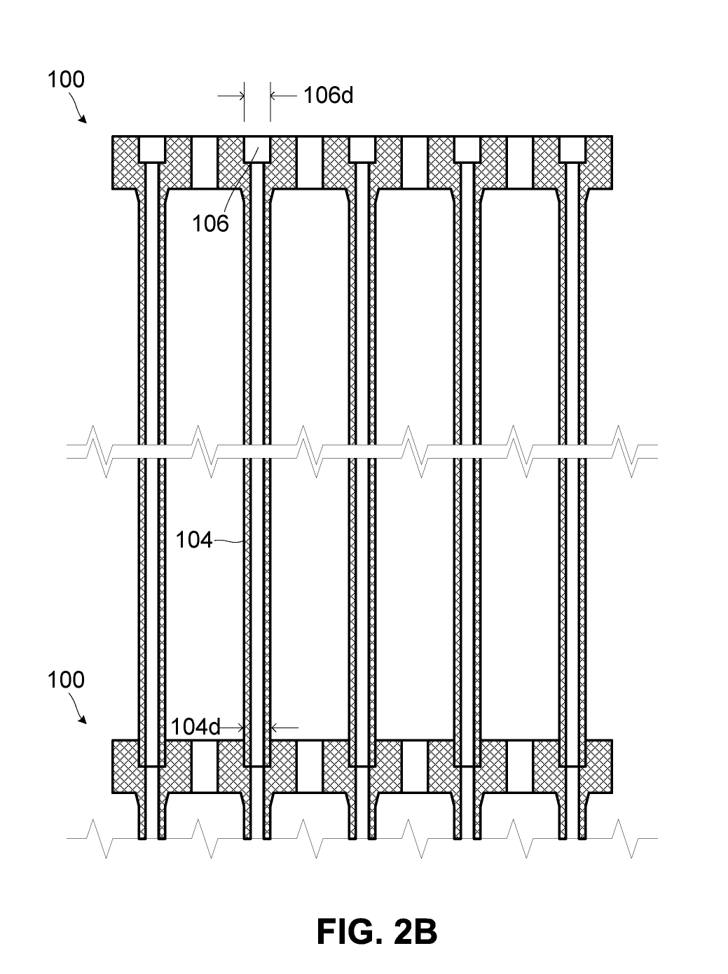

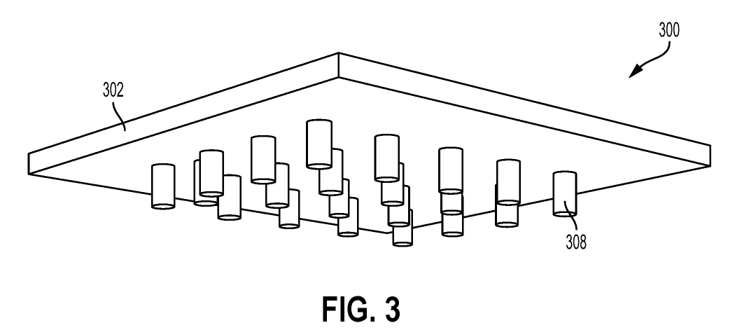

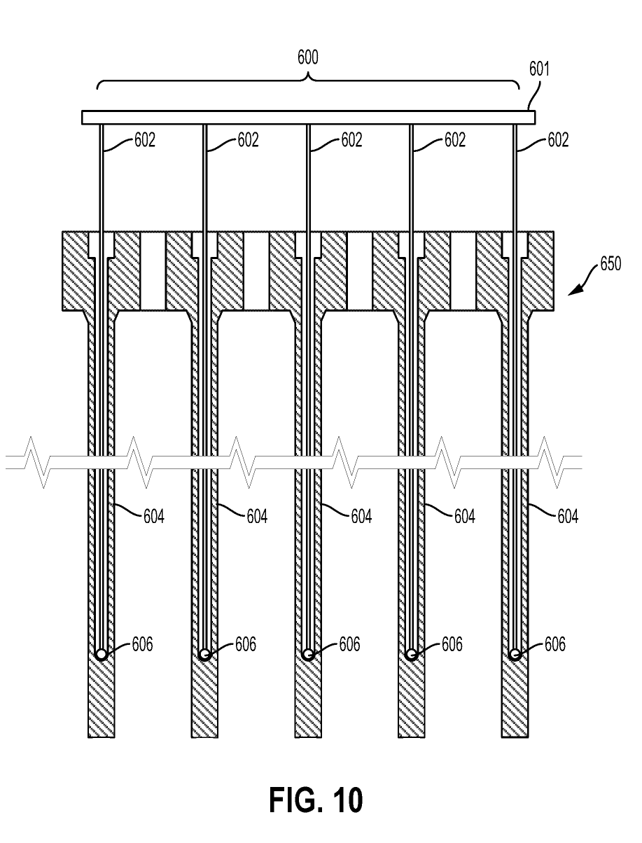

FIGS. 1A, 1B, 2A, and 2B are generally illustrative of an embodiment of the modular tube apparatus. FIGS. 3, 4, 5, 6, 7, 8, and 9 are generally illustrative of an example casting mold. FIG. 10 is generally illustrative of the modular tube apparatus and cathode assembly for use in electrochemically machining the tubes.

### II. Modular Tube Apparatuses

FIGS. 1A and 1B depict a modular tube apparatus 100 for a heat exchanger, according to an example embodiment. Apparatus 100 may include a connecting plate 102 with an arrangement of receiving cups 106 recessed into a top surface of the apparatus 100. Respective small-diameter long-length tubes 104 may extend downward from the bottom surface of the connecting plate 102. These tubes 104 may be arranged in the regular pattern as shown, or in other regular or irregular patterns. The plate 102 may be flat as illustrated or may be non-flat. Preferably, the tubes 104 are arranged in a parallel configuration with each other. As discussed with respect to FIG. 2A, the bottom (distal) ends of the tubes 104 are configured to fit into and mate with the receiving cups 106, such that multiple apparatuses 100 may be stacked in series to form a long tube assembly with a high-density of tubes for use in a heat exchanger.

The apparatus 100 is preferably cast as a metal or metal matrix composite with a unitary body in a permanent mold. Preferred metals include, as non-limiting examples, stainless steel alloys Type 304 or Type 316. The unitary body may be a homogenous casting with metal or metal matrix composite removed via electrochemical machining from small-diameter long-length cylinders to form the small-diameter long-length tubes 104.

For purposes of illustrative clarity only, the apparatus 100 is shown with a five-by-five array of tubes 104 for a total of twenty-five tubes 104. Preferably for a heat exchanger requiring a high heat load, such as one is configured for use in a grid scale energy storage system, a modular tube apparatus, such as apparatus 100, may have on the order of approximately 10¹, 10², 10³, 10⁴, 10⁵ or more tubes per apparatus. The use of the five-by-five array is for illustration only and embodiments including up to and beyond 10⁵ tubes per apparatus are within the scope claimed herein.

In the illustrated embodiment, the tubes 104 are preferably formed as substantially cylindrical tubes. Because the apparatus 100 is preferably cast as unitary body in a permanent mold, it may be necessary to include draft on cast parts that must be removed from the permanent mold, and/or on permanent mold portions that must be removed from cast parts. Accordingly, and for purposes herein, the term “substantially cylindrical” should be understood to mean cylindrical with a 0° or greater draft angle along an exterior surface that may be in contact with a mold wall surface. For practical purposes, the tubes 104 may have an approximately 1.5° draft angle on the exterior surface. Likewise for the connecting plate 102. However, depending on the mold constraints, the draft angle may be less than or greater than 1.5° for various parts. The wall thickness of tubes 104 that are cast may be constant or varied along the length of the tube by varying the cathode or cathode path used for electrochemical machining. Additionally, draft angles may be varied along the length of the tubes 104. For illustrative clarity only, and not as a limitation, all draft angles are drawn at 0° in the illustrative Figures.

Preferably, each of the tubes 104 may be approximately 10 mm or less in width or diameter at the distal end with a length of 100 mm, 500 mm, 1000 mm to 2000 mm or longer. Both smaller and larger diameter tubes 104 are considered and both shorter and longer lengths are considered as well. Length to diameter ratio (or length to width ratio if non-cylindrical) may be tuned for desired thermal transfer properties of the heat exchanger, casting shrinkage and deformation, practical draft angles, or other considerations. For illustrative clarity only, the tubes 104 in FIGS. 1A, 1B, and 2A are shown with a shorter length to diameter ratio than the 50:1. 100:1, and 200:1 ratios described above.

While cylindrical tubes, and matching cylindrical receiving cups, are preferred shapes of tubes 104 and receiving cups 106 due to fluid flow characteristics, mating requirements (including susceptibility to twist), and heat transfer properties, other shapes are also considered, so long as the distal end of a tube 104 is configured to mate with a receiving cup 106 to form a fluid seal. Non-limiting examples include square, hexagonal, or octagonal tubes. The fluid seal may preferably be formed through the use of a brazing material at one or more mating surfaces of the tubes 104 and receiving cups 106, but other non-limiting examples may include compression fitting, locking taper with perpendicular compressive force, welding, gasketing, or other configurations.

A fillet or chamfer 104a may be included at the interface of each tube 104 with the bottom surface of the connecting plate 102. The fillet or chamfer 104a may provide strength at that stress-prone area and/or may provide structural material below the receiving cup, as is evident in the cross-sectional view of FIG. 1C.

While an internal fluid (e.g., a working fluid) may flow through the apparatus 100 in enclosed paths through receiving cups 106, internal connecting fluid paths 112 (illustrated in FIG. 1C), and hollow portions 110 of the tubes 104, an external fluid (e.g., a thermal fluid) may flow across the tube 104 exteriors. Tubes 104 may include fins or other heat transfer aids along the exterior of the tubes 104, including straight fins, helical fins, radial fins, and dimples or protrusions, to aid heat transfer between a working fluid and a thermal fluid.

To enhance and/or allow flow of the external fluid, a second set of fluid paths 108 may extend completely through the connecting plate 102 from the top surface to the bottom surface. The fluid paths 108 may be arranged as shown or in other regular or irregular patterns. Additional or alternatively shaped fluid paths may be added via a mold or other means to optimize the flow of the thermal fluid through the plate 102 to optimize the heat transfer. This may beneficially provide better flow and/or circulation of the external fluid; and, in an embodiment where a shell is sealed to the external periphery of the connecting plate 102, the fluid paths 108 provide a means of fluid flow between apparatuses, such as apparatus 100, connected in series.

FIG. 1C illustrates a cross-section view of modular apparatus 100. A break line illustrates that the length 104L of tubes 104 is preferably much longer than may be practicably depicted in the illustration. Preferably, the tubes 104 have a length 104L to outside width 104d ratio of at least 50:1, 100:1, or 200:1.

In this illustrated embodiment of modular apparatus 100, where the tubes 104 are illustrated as substantially cylindrical, the width 104d of the distal open end of each tube 104 may also be considered the outer diameter of the tube 104. Similarly, where the receiving cups 106 are also illustrated as substantially cylindrical, the bottom width 106d of the receiving cup 106 may be considered the inside diameter of the bottom of the receiving cup 106. In other non-cylindrical embodiments, the widths 104d and 106d may be considered the widths of respective opposing surfaces. For example, for a tube 104 and respective receiving cup 106, each with a regular polygonal contour, the widths 104d and 106d may be measured as flat-to-flat, vertex-to-vertex, or flat-to-vertex.

The distal open end of each tube 104 has an outer contour that conforms to an internal contour of the respective receiving cup 106. In the illustrated cylindrical embodiment, the outer contour of the distal open end of tube is substantially cylindrical with an outer circumferential surface 116. Similarly, the internal contour of the respective receiving cup 106 is substantially cylindrical with an internal circumferential surface 114. The widths 106d and 104d may be sized such that the internal circumferential surface 114 may form a fluid seal with a mating outer circumferential surface 116. Brazing may be used to form the fluid seal, though other configurations are considered, as described above.

Alternatively or additionally, the fluid seal may occur at another surface along the internal and external contours. For example, the fluid seal may occur at a mating interface between the bottom surface of the tube 104 and the annular bottom surface of the receiving cup 106. Again, brazing may be used to form the seal, though other configurations are considered.

As shown in FIG. 1C, each of the receiving cups 106 may be recessed and extend partially through the connecting plate 102 to a distance less than the connecting plate's thickness 102L at the receiving cups. Each receiving cup 106 may be connected to a hollow portion 110 of the respective tube 104 by a fluid path 112 inside the connecting plate 102. Preferably each fluid path 112 and hollow portion 110 of the respective tube 104 create a smooth and straight fluid path from the receiving cup 106 to the distal open end of the tube 104.

FIG. 2A illustrates two modular tube apparatuses 100 connected in series, with tubes 104 seated in respective receiving cups 106. Multiple modular tube apparatuses 100 may accordingly be connected in series to create a very long tube assembly for use in a shell-and-tube heat exchanger. Fluid paths 108 may be present and allow fluid movement not only across the tubes 104 but also through the connecting plates 102.

FIG. 2B illustrates a cross-section view of two modular tube apparatuses 100 connected in series, with tubes 104 seated in respective receiving cups 106. Break lines illustrate that the tubes 104 are longer than may be practicably illustrated. In an embodiment with substantially cylindrical tubes 104, outside diameter 104d at the distal open end of each tube 104 may be sized to create a fluid seal against the inside diameter 106d of receiving cup 106. Braze or other materials may be used to create the fluid seal. As shown in FIG. 2B, stacking modular tube apparatuses 100 in series creates a contiguous fluid path through the tubes 104, allowing for very long fluid paths in small diameter tubes.

### III. Molds for Modular Tube Apparatuses

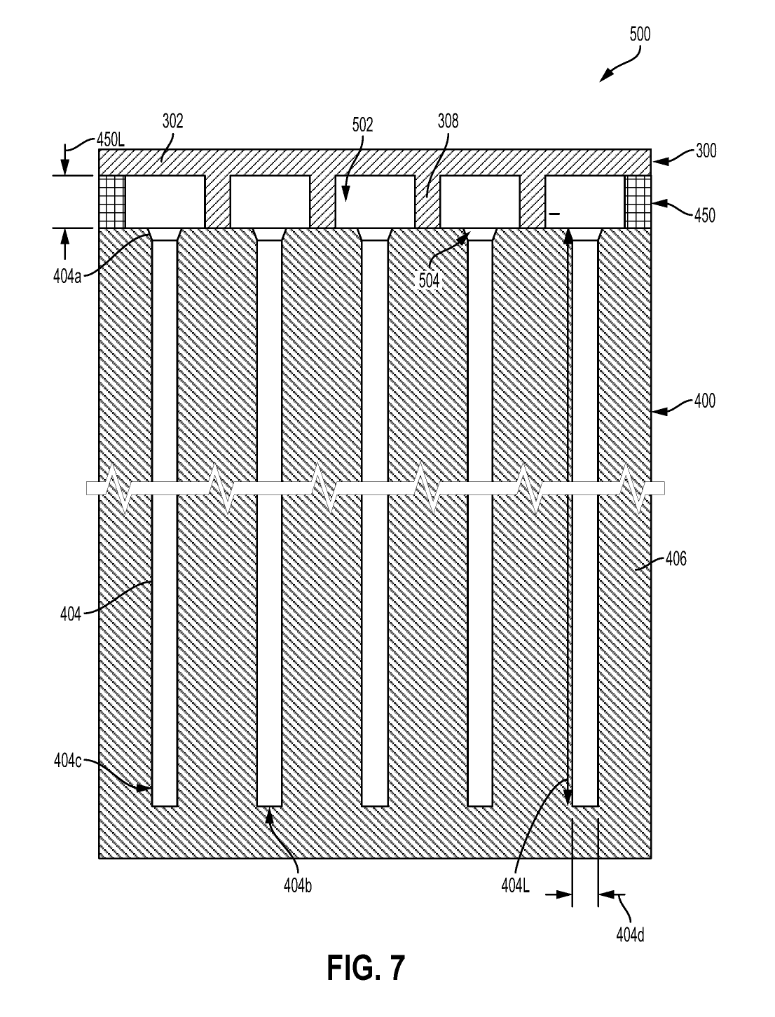

FIGS. 3, 4, and 5 illustrate an example top mold portions 300, 301, and 306 of mold assemblies 500, 501, and 503 (see FIGS. 7, 8, and 9 for further detail) for casting embodiments of unitary modular tube apparatuses described herein. The top mold 300 may be mated with a bottom mold (examples discussed herein) to form a connecting plate (e.g., connecting plate 102) with downward extending solid or partially hollow cylinders that will eventually form flow tubes (e.g., tubes 104).

In a modular tube apparatus cast with the top mold portion embodiment shown in FIG. 3, fluid paths, such as fluid paths 108, may be formed during casting, while the receiving cups and hollow portions of tubes, such as receiving cups 106 and tubes 104 of the modular tube apparatus 100, may be formed by a subsequent electrochemical machining process.

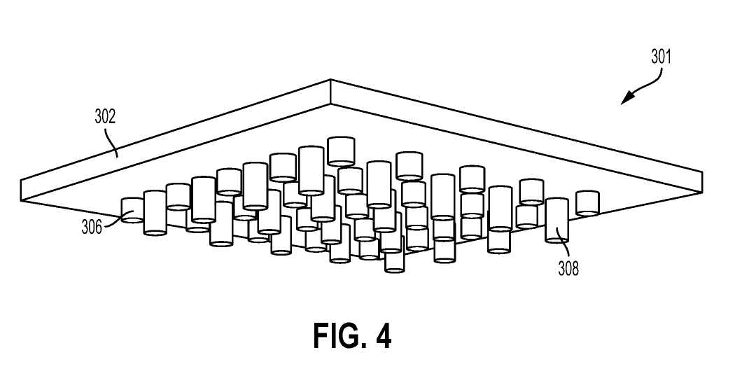

In a modular tube apparatus cast with the top mold portion embodiment shown in FIG. 4, fluid paths and receiving cups may be formed as part of the molding process, while hollow portions of tubes may be formed by a subsequent electrochemical machining process.

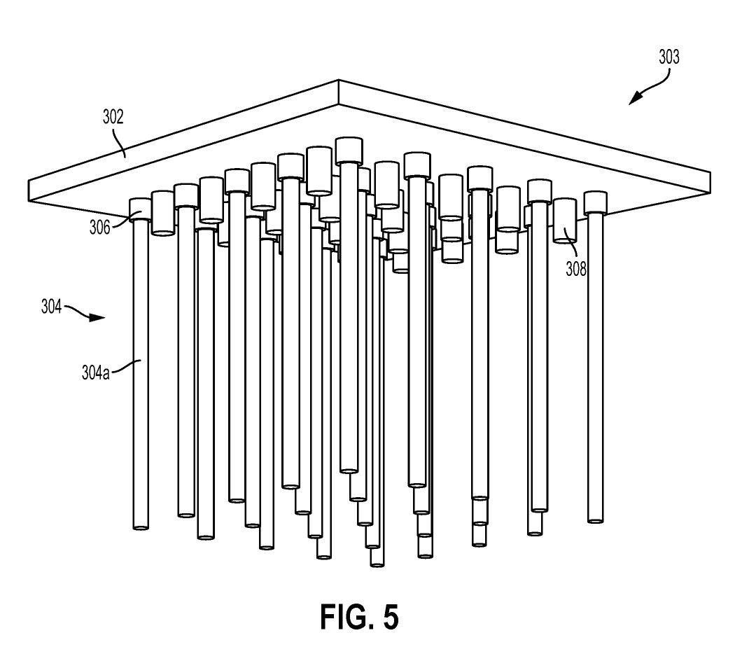

In a modular tube apparatus cast with the top mold portion embodiment shown in FIG. 5, fluid paths, receiving cups, and upper segments of the hollow portions of tubes may be formed as part of the molding process and the remaining segments of the hollow portions of tubes may be formed by a subsequent electrochemical machining process, along with optional final diameter sizing and/or finishing of the upper segments.

Referring now to FIG. 3, the top mold portion 300 may include a top plate 302 and may also include protrusions 308 extending downward from the top plate 302. The protrusions 308 are configured to form fluid paths through a connecting plate in a modular tube apparatus for a heat exchanger, such as, for example, the fluid paths 108 through the connecting plate 102 of the modular tube apparatus 100. As depicted, the protrusions 308 are substantially cylindrical, but they may take other forms as well.

In the alternative embodiment shown in FIG. 4, top mold portion 301 may include a top plate 302 and may also include the protrusions 308 as described above with respect to FIG. 3. Top mold portion 301 may also include protrusions 306 extending downward from the top plate 302. The protrusions 306 are configured to form receiving cups in a modular tube apparatus for a heat exchanger, such as, for example, the receiving cups 106 of the modular tube apparatus 100. As depicted, the protrusions 306 are substantially cylindrical, but may be any shape as discussed herein with respect to receiving cups.

In the alternative embodiment shown in FIG. 5, top mold portion 303 may include a top plate 302 and may also include the protrusions 308 as described above with respect to FIG. 3 and/or the protrusions 306 as discussed with respect to FIG. 4. Top mold portion 303 may further include partial cores 304 extending downward from the protrusions 306 (as illustrated) or from the connecting plate 302 (not illustrated), the latter being an option if, for example, receiving cups are not also formed by the top mold portion 303. The partial cores 304 are configured to form an upper segment of the hollow portions of tubes in a modular tube apparatus for a heat exchanger, such as, for example, an upper segment of the hollow portions 110 of tubes 104 in the modular tube apparatus 100. As depicted, the partial cores 304 are substantially cylindrical, but may be any shape as discussed herein with respect to tubes. Preferably, the partial cores 304 are arranged in a parallel configuration with each other.

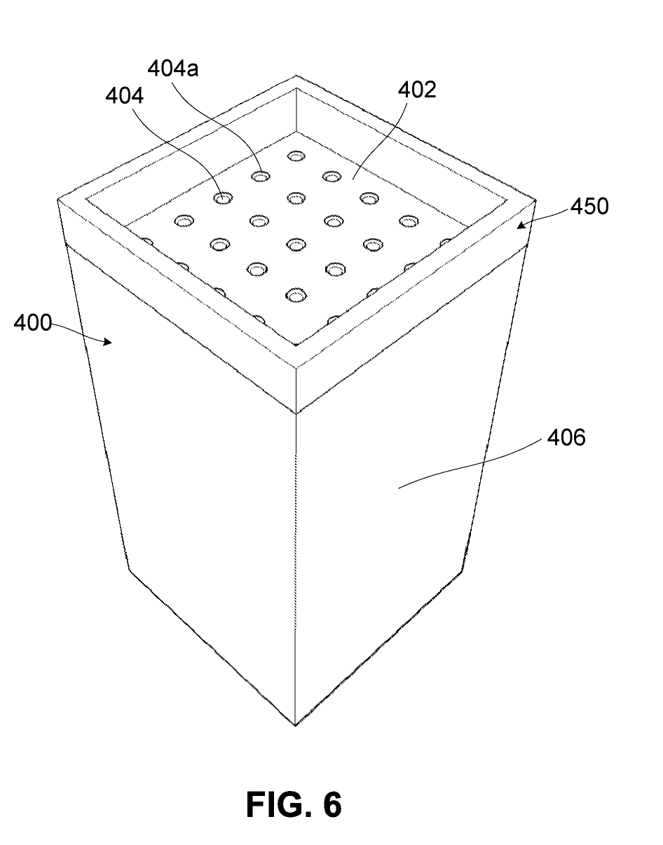

For purposes of illustrative clarity only, the example mold portions 300, 301, 303 and 400 illustrated in FIGS. 3, 4, 5, 6, 7, 8, and 9 are shown with a five-by-five array of partial cores and tube cavities (see FIG. 6 for further detail), for a total of twenty-five tube forming mold sections. Preferably for a large duty heat exchanger, such as one configured for use in a grid scale energy storage system, the mold for a cast modular tube apparatus may have on the order of approximately 10¹, 10², 10³, 10⁴, 10⁵ or more cylinder forming mold sections per casting mold. The use of the five-by-five array is for illustration only and embodiments up to and beyond 10⁵ cylinder forming mold sections is within the scope of the claims herein.

FIG. 6 illustrates an example bottom mold portion 400 of a mold assembly for casting embodiments of unitary modular tube apparatuses described herein. Bottom mold portion 400 includes a bottom block 406 and a top surface 402. Extending downward from the top surface 402 are cavities 404. In conjunction with the top mold portion 300, the cavities 404 are configured to form solid or partially hollow cylinders which may be electrochemically machined to form the tube portions of a modular tube apparatus for a heat exchanger, such as, for example, the tubes 104 in the modular tube apparatus 100. As depicted, the cavities 404 are substantially cylindrical, but may be any shape as discussed herein with respect to tubes. Preferably, the cavities 404 are arranged in a parallel configuration with each other. Each cavity 404 may have a chamfer 404a, a convex fillet, or other formation configured to provide strength and/or structural material below a molded receiving cup.

FIG. 6 also illustrates an example middle mold portion 450. Middle mold portion 450 may take the form of a wall that seals between a component of a top mold portion, for example the top plate 302 of top mold portion 300, 301, or 303, and a component of a bottom mold portion, for example the top surface 402 of bottom mold portion 400. The middle mold portion 450 may extend around the periphery of a void space that is used to form a connecting plate, for example it may extend around the periphery of a void space between a top plate 102 and a bottom block 406.

In the example embodiment depicted in FIG. 6 and FIGS. 7, 8, and 9, middle mold portion 450 is depicted as a separate mold portion, but it may also be fixed or unitary with bottom mold portion 400 or fixed or unitary with top mold portion 300, 301, or 303.

FIGS. 7, 8, and 9 illustrate example embodiments of an assembled mold assembly 500, 501, and 503, respectively, which may include top mold portion 300, 301, and 303, respectively, middle mold portion 450, and bottom mold portion 400.

In one embodiment shown in FIG. 7 with top mold portion 300, top plate 302 may be positioned opposite and at a distance 450L above the top surface of bottom block 400. The positioning creates a void space 502 which will form a connecting plate, such as connecting plate 102, where the distance 450L corresponds to a thickness of the connecting plate. Middle mold portion 450 surrounds the perimeter and seals the void space 502 for the connecting plate.

Protrusions 308 may also extend downward from top plate 302 all the way through the void space 502 and form a seal with the top surface 402 of the bottom block 406. In the illustrated embodiment, the protrusions 308 may extend to and contact a flat top surface 402 of the bottom block 406 to form through-hole fluid paths in a cast connecting plate, such as fluid paths 108; however, other configurations are also possible to form through-hole fluid paths through the connecting plate. For example, top surface 402 may include slight recesses into which protrusions 308 seat, while still forming a seal with the top surface 402 around the perimeter of the protrusions 308.

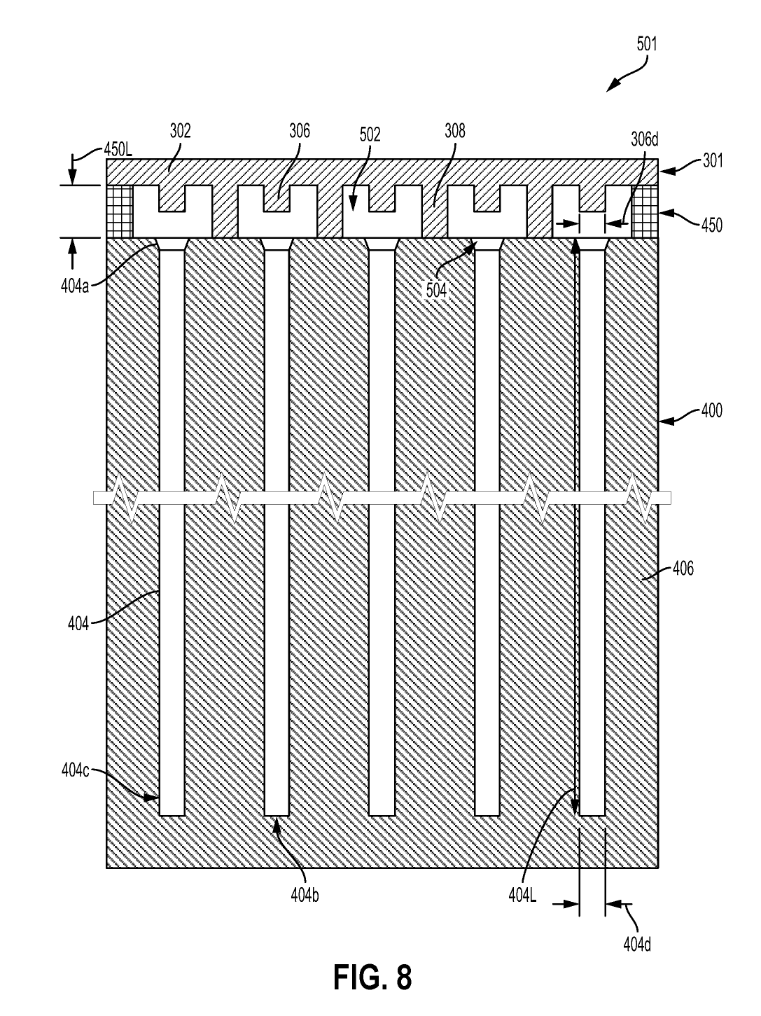

In an alternative embodiment, shown in FIG. 8 with top mold portion 301, within the connecting plate void space 502 protrusions 306 extend downward from the top plate 302 to a depth less than the distance 450L, so as to form receiving cups in a cast connecting plate, such as receiving cups 106 in connecting plate 102. The protrusions 306 are arranged opposite the cavities 404 in the bottom block 406. The protrusions 306 may define an outer contour that conforms to an internal contour at the base 404c of a respective cavity 404.

As previously described, bottom block 406 may include a chamfer 404a at each cavity 404 opening at the top surface of the bottom block. The chamfer 404a partially defines a void space 504 configured to provide strength and/or structural material below the receiving cup 106 in the cast apparatus.

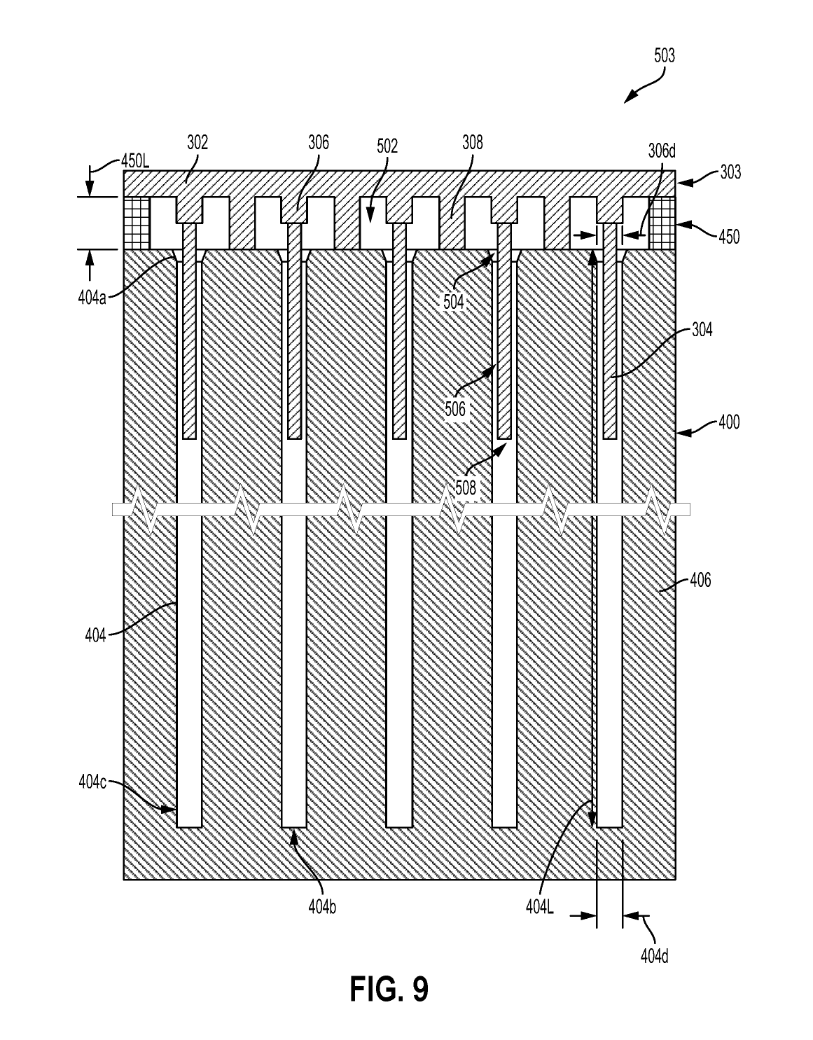

In an alternative embodiment, shown in FIG. 9 with top mold portion 303, partial cores 304 may extend downward from the bottom of the protrusions 306 (or from the bottom of top plate 302 if protrusions 306 are not present) and into the respective cavities 404 but stopping short of the bottom of the cavities 404. The partial cores 304 will thus partially define void spaces 504, 506, and 508 and form an upper segment of a hollow portion 110 of the tubes 104.

Mold assemblies for casting unitary modular tube apparatuses such as mold assembly 500, are preferably permanent molds, though portions or sections may be non-permanent (e.g., sand casting). To the extent that mold assembly 500 includes permanent mold portions, it may be necessary to include draft on areas that must be separated from the casting. For practical purposes, draft angles may be approximately 1.5°. However, depending on the mold constraints of a particular embodiment, the draft angle may be less than or greater than 1.5°. Accordingly, and for purposes herein, the term “substantially cylindrical” should be understood to mean cylindrical with a 0° or greater draft angle. Draft angles may be varied along the length of the cavity 404.

Preferably, each of the cavities 404 may have a width or diameter 404d of approximately 10 mm or smaller in diameter at the bottom with a length 404L of 100 mm, 500 mm, 1000 mm to 2000 mm or longer. Both smaller and larger widths/diameters 404d are considered and both shorter and longer lengths 404L are considered as well. Length to diameter ratio (or length to width ratio if non-cylindrical) may be tuned for desired thermal transfer properties of the heat exchanger, casting shrinkage and deformation, practical draft angles, or other considerations. For illustrative clarity only, the cavities 404 in FIGS. 6, 7, 8, and 9 are shown with a shorter length to diameter ratio than the 50:1. 100:1, and 200:1 ratios described herein. A break line is used in FIGS. 7, 8, and 9 to illustrate that the lengths are preferably much longer than may be practicably depicted in the illustration.

Cavities 404, protrusions 306, and partial cores 304, are preferably shaped as substantially cylindrical due to fluid flow characteristics, mating requirements (including susceptibility to twist), and heat transfer properties. However, other shapes are also considered. As long as the distal end of a formed tube may mate with a formed receiving cup to form a fluid seal, other configurations are considered, including the non-limiting examples of square, hexagonal, or octagonal forms.

In the illustrated embodiment of mold assemblies 500, 501, and 503 where the cavities 404 are illustrated as substantially cylindrical, the width 404d of the bottom end of each cavity 404 may also be considered the inner diameter of the cavity 404. Similarly, where the protrusions 306 are also illustrated as substantially cylindrical, the bottom width 306d of the protrusions 306 may be considered the outside diameter of the bottom of the protrusions 306. In other non-cylindrical embodiments, the widths 404d and 306d may be considered the widths of respective opposing surfaces. For example, regular polygonal contours, the widths 404d and 306d may be measured as flat-to-flat, vertex-to-vertex, or flat-to-vertex.

The mold assemblies 500, 501, and 503 are preferably constructed as reusable permanent molds and of materials sufficient to withstand repeated high-temperature casting of materials such as metal or metal matrix composites, including stainless steel alloys Type 304 or Type 316. For example, each mold may be formed as a ceramic mold using laser-based rapid prototyping, a graphite or graphite/metal composite mold, or other rapid prototyping formed mold that may allow the long and thin forms required of the cavities. For metal casting, and particularly stainless steel casting, the mold assembly should be capable of withstanding a casting temperature of approximately 1350° C.

Various casting methods may be used with the mold assemblies 500, 501, and 503. For example, centrifugal, spin, vacuum, low-pressure, liquid metal pumping, and high-pressure casting methods may be employed depending on mold design parameters and desired or acceptable finish and/or porosity.

Risers, gates, vents, sprues/ports and runners may be necessarily and additionally present in any claimed mold assembly, including mold assemblies 500, 501, and 503. Inclusion of some or all of such casting mold structures is considered, though not shown, and such casting mold structures may be included in example mold assemblies 500, 501, and 503 and other embodiments.

### IV. Methods for Casting and Electrochemically Machining for Modular Tube Apparatus

A casting and electrochemical machining process may be accomplished by providing a mold assembly according to embodiments herein, coupling together the portions of the mold assembly to form a mold chamber, infiltrating the mold chamber with a molten material, decoupling some or all the mold portions in a manner sufficient to remove the cast modular tube apparatus, and electrochemically machining the cast modular tube apparatus to form a plurality of tubes comprising distal open ends and hollow portions.

Electrochemical machining is a method of removing metal by advancing a charged electrode (e.g., cathode) into a conductive workpiece (e.g., anode) in the presence of a conductive fluid (electrolyte). In various embodiments described herein, a cathode assembly comprising a plurality of wire cathodes may be used to simultaneously create multiple tubes in modular tube apparatus by forming hollow portions in multiple solid or partially hollow cylinders. A current may be passed through the cathode assembly and the electrolyte to the plurality of cylinders in order to remove cast material from the plurality of cylinders to form a plurality of tubes.

As a specific example method to cast and electrochemically machine an embodiment of the modular tube apparatus 100 described herein, the following steps may be accomplished.

A bottom mold portion may be provided. The bottom mold portion may include a bottom block with a top surface. A plurality of cavities in the bottom block may extend downward from the top surface into the interior of the bottom block.

A top mold portion may be provided. The top mold portion may include a top plate positioned opposite and at a first distance from the top surface of the bottom block. In one embodiment, a first plurality of protrusions may extend downward from the top plate. Each protrusion of the plurality may form a seal at the top surface of the bottom block. In another embodiment, the plurality of protrusions may be absent.

In one embodiment, a second plurality of protrusions may extend downward from the top plate to a length less than the first distance. Each protrusion of the second plurality may be disposed opposite a respective cavity of the plurality of cavities. Each protrusion of the first plurality may define an outer contour that conforms to an internal contour at a base of the respective cavity.

In another embodiment, a plurality of partial cores may extend downward from each protrusion of the second plurality of protrusions or from the top plate if the second plurality of protrusions is not present. Each core may be disposed within the respective cavity and form a respective void space in each cavity.

A middle mold portion may be provided. The middle mold portion may include a wall that forms a seal between the top plate and the bottom block around the periphery of a void space between the top plate and the bottom block.

The top mold portion, middle mold portion, and bottom mold portion may be coupled together to form a mold chamber. As non-limiting examples, the portions may be bolted or clamped together with internal and/or external bolts or clamps.

The mold chamber may take the negative form of a modular tube apparatus with solid or partially hollow cylinders in place of the tubes and with or without additional risers, gates, ports, or structural supports, and the negative form be configured to account for shrinkage or growth in the casting material. The mold chamber may be infiltrated with a molten material. Preferably materials include Type 304 or 316 stainless steel.

Following a dwell period after infiltration, one more mold portions mays be decoupled and removed. In the embodiment illustrated as mold assembly 500, the top portion 300 with may be decoupled and removed. The cast modular tube apparatus with the connecting plate and a plurality of cylinders may be retained in the bottom mold portion for subsequent electrochemical machining, or it may be removed and placed in a fixture for subsequent electrochemical machining.

As shown in FIG. 10, a cathode assembly 600 may be provided along with a cast modular tub apparatus 650 in which the cylinders 604 have been fully or partially hollowed out. The cathode assembly may comprise a base 601 and a plurality of wire cathodes 602 arranged to match the arrangement of solid or partially hollow cylinders that will form tubes, such as tubes 104. An electrolyte solution may be flushed over, or preferably pumped at high pressure around, each wire cathode 602. A current may be passed to each wire cathodes 602, through the electrolyte, and to an interior portion of each respective cylinder 604, gradually consuming the cast material (which may act as an anode) from the plurality of cylinders to form a plurality of tubes comprising a distal open end and a hollow portion extending from the distal open end to the connecting plate.

A plurality of the wire cathodes 602 may be configured to pass through the plurality of cylinders 604 simultaneously such that material is removed from each of the plurality of cylinders 604 at the same time. Each of the plurality of wire cathodes 602 may comprise a rod portion with a spherical tip 606 at the distal ends. The diameter of the spherical ends 606 may be larger than the diameter to of the wire cathode's rod portion. The diameter of the spherical tips 606 may be approximately the same as the desired internal diameter of the tubes 604, such as the hollow portion 110 of the respective tube 104 in FIG. 1C. For example, the diameter of the spherical tips 606 may be 10 mm or less.

The method may further comprise electrochemically machining a plurality of receiving cups, such as receiving cups 106. The inner diameters of the receiving cups may be approximately the same size as the outer diameter of each of the plurality of tubes. To create the receiving cups, cathode assembly 600 may be moved in, for example, three axes during the electrochemical machining process so that the spherical tips 606 create the receiving cup.

The method may be used to form a plurality of modular tube apparatuses. The plurality of modular tube apparatuses may be joined by methods known in the art, such as brazing, soldering, or welding.

During the electrochemical machining process, the metal anode is consumed and metal is put into the electrolyte. The metal put into the electrolyte may be recovered for future use. Such recovery methods may include electrochemical methods (e.g., plating the metal onto another electrode) or filtration methods.

### V. Conclusion

The particular arrangements shown in the Figures should not be viewed as limiting. It should be understood that other embodiments may include more or less of each element shown in a given Figure. Further, some of the illustrated elements may be combined or omitted. Yet further, an exemplary embodiment may include elements that are not illustrated in the Figures. Additionally, while various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims. Other embodiments may be utilized, and other changes may be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are contemplated herein.

What is claimed is:

1. A mold assembly comprising:
a bottom mold portion comprising:
a bottom block comprising a top surface, and
a plurality of cavities in the bottom block extending downwardly from the top surface to a first depth;
a top mold portion comprising:
a top plate positioned opposite and at a first distance from the top surface of the bottom block, and
a plurality of protrusions extending downwardly from the top plate, wherein each protrusion of the plurality of protrusions forms a seal at the top surface of the bottom block; and
a middle mold portion comprising a wall that forms a seal between the top plate and the bottom block around the periphery of a void space between the top plate and the bottom block.

2. The mold assembly of claim 1, further comprising a second plurality of protrusions extending downwardly from the top plate to a length less than the first distance, wherein each protrusion of the second plurality of protrusions is disposed opposite a respective cavity of the plurality of cavities, and wherein each protrusion of the second plurality of protrusions defines an outer contour that conforms to an internal contour at a base of the respective cavity.

3. The mold assembly of claim 1, further comprising a plurality of cores extending downwardly from each protrusion of the second plurality of protrusions, wherein each core of the plurality of cores is disposed within and extends to less than the first depth of the respective cavity of the plurality of cavities.

4. The mold assembly of claim 1, wherein each cavity of the plurality of cavities is substantially cylindrical.

5. The mold assembly of claim 1, wherein each cavity of the plurality of cavities in the bottom block comprises a chamfer at the top surface of the bottom block.

6. The mold assembly of claim 1, wherein each cavity of the plurality of cavities in the bottom block comprises a convex fillet at the top surface of the bottom block.

7. The mold assembly of claim 1, wherein a ratio of the first depth to a bottom width of each cavity of the plurality of cavities in the bottom block is at least 50:1.

8. The mold assembly of claim 1, wherein a ratio of the first depth to a bottom width of each cavity of the plurality of cavities in the bottom block is at least 100:1

9. The mold assembly of claim 1, wherein the middle mold portion is integral with the top mold portion.

10. The mold assembly of claim 1, wherein the middle mold portion is integral with the bottom mold portion.

11. A method of forming a modular tube apparatus comprising the steps of:
providing a modular tube apparatus casting, the casting comprising:
a connecting plate, and
a plurality of cylinders extending downward from the connecting plate;
providing an electrochemical machining cathode, the cathode comprising:
a rod, and
a spherical tip at an end of the rod;
contacting the spherical tip of the electrochemical machining cathode to the casting opposite of one of the plurality of cylinders; and
moving the electrochemical machining cathode through the cylinder to form a hollow tube.

12. The method of claim 11, further comprising:
electrochemically machining a receiving cup,
wherein the receiving cup is recessed into a top surface of the connecting plate to a depth partially through the connecting plate and disposed opposite a respective cylinder of the plurality of cylinders, and
wherein the receiving cup defines an internal contour that conforms to an outer contour of the distal open end of the respective tube of the plurality of tubes.

13. A method of forming a modular tube apparatus comprising the steps of:
providing a modular tube apparatus casting, the casting comprising:
a connecting plate, and
a plurality of cylinders extending downward from the connecting plate;
providing an electrochemical machining assembly, the assembly comprising:
a base, and
a plurality of wire cathodes, each wire cathode comprising a spherical tip, wherein each wire cathode of the plurality of wire cathodes is arranged to align with a respective cylinder of the plurality of cylinders;
contacting the spherical tips of the plurality of wire cathodes to the casting; and
moving the plurality of wire cathodes through the plurality of cylinders to form a plurality of hollow tubes.

14. The method of claim 13, further comprising:
configuring the plurality of wire cathodes to pass through the plurality of cylinders simultaneously such that material is removed from each of the plurality of cylinders at the same time.

15. The method of claim 13, further comprising:
electrochemically machining a plurality of receiving cups,
wherein each receiving cup of the plurality of receiving cups is recessed into a top surface of the connecting plate to a depth partially through the connecting plate and disposed opposite a respective cylinder of the plurality of cylinder, and
wherein each receiving cup of the plurality of receiving cups defines an internal contour that conforms to an outer contour of the distal open end of the respective cylinder of the plurality of cylinders.
